(19) United States
(12) Patent Application Publication
(10) Pub. No.: US 2026/0333068 A1
(43) Pub. Date: Oct. 22, 2026

(54) CONTROL SYSTEM, CONTROL DEVICE, CONTROL METHOD, AND NON-TRANSITORY COMPUTER READABLE MEDIUM

(71) Applicant: NEC CORPORATION, Minato-ku, Tokyo (JP)

(72) Inventors: Eiji TAKAHASHI, Tokyo (JP); Takeo ONISHI, Tokyo (JP); Yoshiaki NISHIKAWA, Tokyo (JP); Kenji KAWAGUCHI, Tokyo (JP); Yoshinori WATANABE, Tokyo (JP); Masayuki UEDA, Tokyo (JP); Hideki KOZUKA, Tokyo (JP); Rumi MATSUMURA, Tokyo (JP); Katsunori DATE, Tokyo (JP); Takeshi IEIRI, Tokyo (JP)

(73) Assignee: NEC CORPORATION, Minato-ku, Tokyo (JP)

(21) Appl. No.: 18/994,748

(22) PCT Filed: Aug. 18, 2022
(86) PCT No.: PCT/JP2022/031251

§ 371 Date: Jan. 15, 2025

(51) Int. Cl. H04W 24/02; H04L 41/16; H04W 64/00; H04W 88/12

(52) U.S. Cl. CPC H04W 24/02; H04L 41/16; H04W 64/00; H04W 88/12

(57) ABSTRACT

A control method includes collecting specifying data to be used for specifying by a specific model configured to specify control related to a radio network, and transmitting the specifying data to another control system that performs learning by a learning model as learning data to be used for the learning model configured to learn the control related to the radio network.

### TECHNICAL FIELD

The present disclosure relates to a control system, a control device, a control method, a control program, and a non-transitory computer readable medium.

### BACKGROUND ART

In recent years, 5G (5th Generation) has been introduced as a radio communication technology for realizing large capacity, low delay, and multi-connectivity. In a next-generation radio communication system including 5G, in order to respond with an advanced and complicated system, a radio access network (RAN) is being opened, and in the open radio access network (O-RAN) alliance, opening of the RAN and intelligentization thereof are being discussed.

Related Patent Literature 1 and Non Patent Literature 1 describe that a Non-RT (real time) RIC and a Near-RT RIC are provided as a RAN intelligent controller (RIC) that intelligently controls a RAN by utilizing artificial intelligence/machine learning (AI/ML). The Near-RT RIC is disposed near the E2 node including an O-RAN distributed unit (O-DU) and an O-RAN central unit (O-CU), and controls the RAN in near real time. The Non-RT RIC is disposed at a place away from the E2 node and controls the RAN in non-real time.

### CITATION LIST

### Patent Literature

Patent Literature 1: International Patent Publication No. WO 2022/070363 A

### Non Patent Literature

Non Patent Literature 1: O-RAN ALLIANCE, O-RAN Working Group 2, “AI/ML workflow description and requirements”, Technical Report, O-RAN. WG2.AIML-v01.03, 2021.07.20

### SUMMARY OF INVENTION

### Technical Problem

According to Patent Literature 1 and Non Patent Literature 1, it is possible to arrange the inference model for inferring the control of the RAN and the learning model for performing learning to construct the inference model in any one of the Near-RT RIC and the Non-RT RIC, or dispersedly arrange them. As a result, it is possible to perform learning by the learning model using the data being operated while executing control by the inference model. However, since it is necessary to collect learning data in order to perform learning by the learning model, a load may be applied to a transmission path, an apparatus, or the like that transmits data.

In view of such problems, an object of the present disclosure is to provide a control system, a control device, a control method, and a non-transitory computer readable medium capable of suppressing a load.

### Solution to Problem

A control system according to the present disclosure includes: a collection means for collecting specifying data to be used for specifying by a specific model configured to specify control related to a radio network; and a transmission means for transmitting the specifying data to another control system that performs learning by a learning model as learning data to be used for the learning model configured to learn the control related to the radio network.

A control system according to the present disclosure includes: a reception means for receiving, as learning data, specifying data collected by another control system to specify control related to a radio network by a specific model from the other control system; and a learning means for learning control related to the radio network by a learning model using the learning data.

A control device according to the present disclosure includes: a collection means for collecting specifying data to be used for specifying by a specific model configured to specify control related to a radio network; and a transmission means for transmitting the specifying data to another control system that performs learning by a learning model as learning data to be used for the learning model configured to learn the control related to the radio network.

A control device according to the present disclosure includes: a reception means for receiving, as learning data, specifying data collected by another control system to specify control related to a radio network by a specific model from the other control system; and a learning means for learning control related to the radio network by a learning model using the learning data.

A control method according to the present disclosure includes: collecting specifying data to be used for specifying by a specific model configured to specify control related to a radio network; and transmitting the specifying data to another control system that performs learning by a learning model as learning data to be used for the learning model configured to learn the control related to the radio network.

A control method according to the present disclosure includes receiving, as learning data, specifying data collected by another control system to specify control related to a radio network by a specific model from the other control system; and learning control related to the radio network by a learning model using the learning data.

A non-transitory computer readable medium according to the present disclosure is a non-transitory computer readable medium storing a control program for causing a computer to execute: collecting specifying data to be used for specifying by a specific model configured to specify control related to a radio network; and transmitting the specifying data to another control system that performs learning by a learning model as learning data to be used for the learning model configured to learn the control related to the radio network.

A non-transitory computer readable medium according to the present disclosure is a non-transitory computer readable medium storing a control program for causing a computer to execute: receiving, as learning data, specifying data collected by another control system to specify control related to a radio network by a specific model from the other control system; and learning control related to the radio network by a learning model using the learning data.

### Advantageous Effects of Invention

According to the present disclosure, it is possible to provide a control system, a control device, a control method, a control program, and a non-transitory computer readable medium capable of suppressing a load.

### BRIEF DESCRIPTION OF DRAWINGS

FIG. 1 is a configuration diagram illustrating an outline of a first control system according to an example embodiment.

FIG. 2 is a configuration diagram illustrating an outline of a second control system according to an example embodiment.

FIG. 3 is a configuration diagram illustrating an outline of a first control device according to an example embodiment.

FIG. 4 is a configuration diagram illustrating an outline of a second control device according to an example embodiment.

FIG. 5 is a flowchart illustrating an outline of a first control method according to an example embodiment.

FIG. 6 is a flowchart illustrating an outline of a second control method according to an example embodiment.

FIG. 7 is a configuration diagram illustrating a configuration example of a RAN system according to a first example embodiment.

FIG. 8 is a diagram for explaining a flow of data in a comparative example.

FIG. 9 is a diagram for explaining a flow of data in a first example embodiment.

FIG. 10 is a configuration diagram illustrating a configuration example of a Near-RT RIC according to the first example embodiment.

FIG. 11 is a configuration diagram illustrating the configuration example of the Non-RT RIC according to the first example embodiment.

FIG. 12 is a flowchart illustrating an outline of learning processing in a RAN system according to the first example embodiment.

FIG. 13 is a flowchart illustrating an operation example of learning processing in the RAN system according to the first example embodiment.

FIG. 14 is a sequence diagram illustrating an operation example of the learning processing in the RAN system according to the first example embodiment.

FIG. 15 is a configuration diagram illustrating a configuration example of a Near-RT RIC according to a second example embodiment.

FIG. 16 is a configuration diagram illustrating a configuration example of a Near-RT RIC according to a third example embodiment.

FIG. 17 is a configuration diagram illustrating a configuration example of a Near-RT RIC according to a fourth example embodiment.

FIG. 18 is a configuration diagram illustrating a configuration example of a RAN system according to a fifth example embodiment.

FIG. 19 is a configuration diagram illustrating an outline of hardware of a computer according to an example embodiment.

### EXAMPLE EMBODIMENT

Hereinafter, example embodiments will be described with reference to the drawings. In the drawings, the same elements are denoted by the same reference signs, and redundant description will be omitted as necessary.

For example, in a case where an inference model is arranged in a Near-RT RIC and a learning model is arranged in a Non-RT RIC, a method is considered in which the Near-RT RIC collects necessary data from an E2 node for inference and the Non-RT RIC collects necessary data from the E2 node for learning. The inventor of the present disclosure has studied such a collection method, and has found a problem that a load may be applied to the E2 node and a transmission path for transmitting data. Therefore, in the example embodiment, it is possible to reduce the load on the E2 node and the transmission path for transmitting data.

### Outline of Example Embodiment

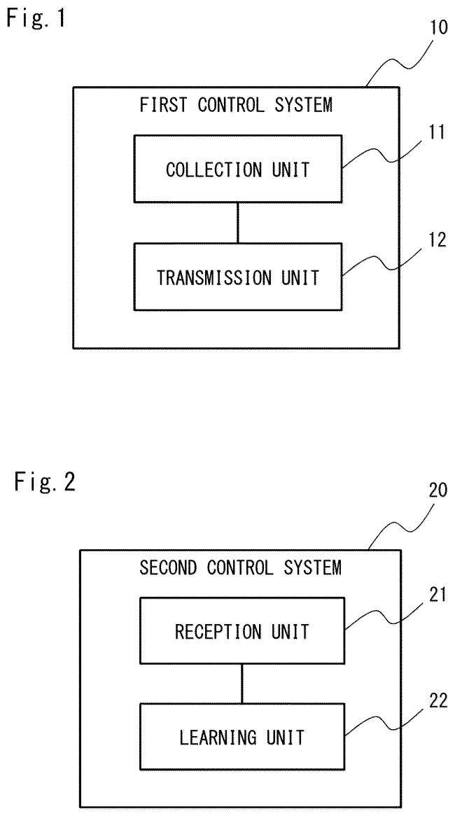

First, outlines of example embodiments will be described. FIG. 1 illustrates a schematic configuration of a first control system 10 according to an example embodiment, and FIG. 2 illustrates a schematic configuration of a second control system 20 according to an example embodiment. For example, the first control system 10 and the second control system 20 constitute a system that controls a radio network such as a RAN. For example, the first control system 10 includes a Near-RT RIC, and the second control system 20 includes, but is not limited to, a Non-RT RIC.

As illustrated in FIG. 1, the first control system 10 includes collection unit 11 and transmission unit 12. The collection unit 11 collects specifying data to be used for specifying by a specific model that specifies control related to a radio network. The collection unit 11 collects the specifying data from a RAN including an O-DU and an O-CU. The control related to the radio network is, for example, control of the operation of the RAN, and is control of a radio resource allocation scheduler, a beam, a handover, and the like that can be performed by setting the O-DU or the O-CU. The specific model is an inference model that infers control related to a radio network, and it can also be said that the specifying data is inference data used for inference. For example, the specific model specifies the control of the RAN according to data such as radio quality collected from the RAN. The specific model is, for example, included in the first control system 10, but may be located outside of the first control system 10.

The transmission unit 12 transmits the specifying data collected by the collection unit 11 to the second control system 20 that performs learning by the learning model as learning data to be used for a learning model that learns control related to a radio network. For example, the learning model is a model for constructing the specific model. The learning data transmitted by the transmission unit 12 may include specified result data that is a result specified by the specific model. The specified result data is, for example, analysis information obtained by analyzing the specifying data, control information for controlling the RAN, and the like. Furthermore, the transmission unit 12 may transmit the learning data according to a communication status between the first control system 10 and the second control system 20. For example, the transmission unit 12 may transmit the learning data according to availability of the interface connected to the second control system 20.

As illustrated in FIG. 2, the second control system 20 includes a reception unit 21 and a learning unit 22. The reception unit 21 receives the learning data transmitted from transmission unit 12 of the first control system 10. That is, the specifying data collected by the first control system 10 to specify the control related to the radio network by the specific model is received as the learning data.

The learning unit 22 learns the control related to the radio network by the learning model using the learning data received by the reception unit 21. That is, control of the RAN according to data such as radio quality is learned. For example, the learning model is included in the second control system 20, but may be arranged outside the second control system 20. The learning unit 22 applies the learned learning model learned by using the learning data to the specific model of the first control system 10.

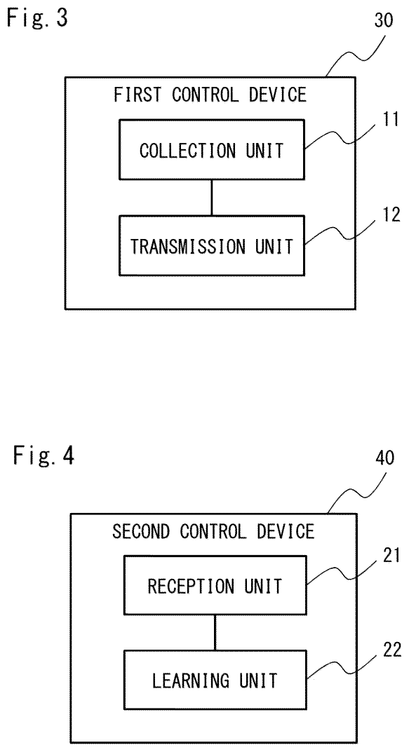

Note that each of the first control system 10 and the second control system 20 may be configured by one apparatus or may be configured by a plurality of apparatuses. FIG. 3 illustrates a configuration example of a first control device 30 according to an example embodiment, and FIG. 4 illustrates a configuration example of a second control device 40 according to an example embodiment. As illustrated in FIG. 3, the first control device 30 may include the collection unit 11 and the transmission unit 12 illustrated in FIG. 1. The present disclosure is not limited to this example, and the collection unit 11 and the transmission unit 12 may be mounted on another device. As illustrated in FIG. 4, the second control device 40 may include the reception unit 21 and the learning unit 22 illustrated in FIG. 2. The present disclosure is not limited to this example, and the reception unit 21 and the learning unit 22 may be mounted on another device. Similarly to the first control system 10 and the second control system 20, for example, the first control device 30 may be a Near-RT RIC, and the second control device 40 may be a Non-RT RIC.

In addition, some or all of the first control system 10 and the second control system 20 may be arranged on an edge or a cloud by using a virtualization technology or the like. They may be arranged at specific places or may be arranged in a plurality of places in a distributed manner. The edge is a place or a base on the base station side including an O-DU and an O-CU. The cloud is a place or infrastructure on a core network side away from a base station. For example, the collection unit 11 and the transmission unit 12 may be arranged at an edge, and the reception unit 21 and the learning unit 22 may be arranged in a cloud. In addition, the collection unit 11, the transmission unit 12, the reception unit 21, and the learning unit 22 may be arranged in a distributed manner.

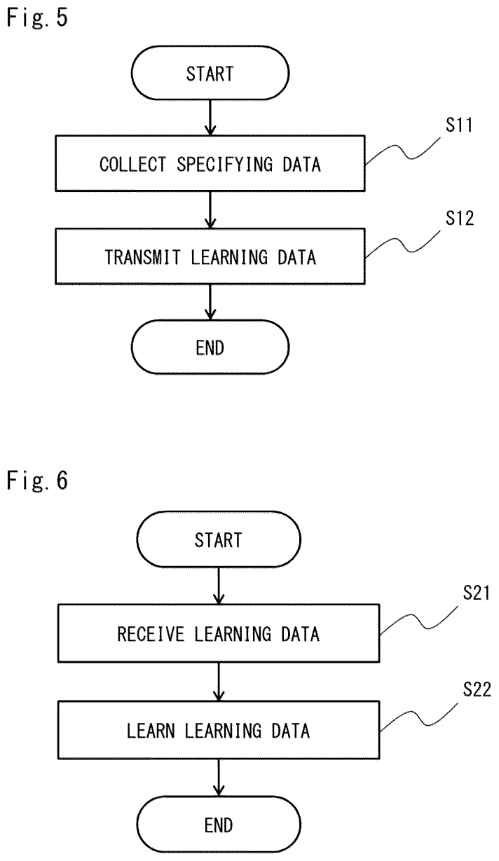

FIG. 5 illustrates a first control method according to an example embodiment, and FIG. 6 illustrates a second control method according to an example embodiment. For example, the first control method is executed by the first control system 10 in FIG. 1 or the first control device 30 in FIG. 3. The second control method is executed by the second control system 20 in FIG. 2 or the second control device 40 in FIG. 4.

As illustrated in FIG. 5, the collection unit 11 collects specifying data to be used for specifying by a specific model for specifying control related to a radio network (S11). Next, the transmission unit 12 transmits the collected specifying data to the second control system 20 that performs learning by the learning model as learning data to be used for a learning model that learns control related to a radio network (S12).

Next, as illustrated in FIG. 6, the reception unit 21 receives the learning data transmitted from the transmission unit 12 of the first control system 10, that is, the learning data that is the data collected as the specifying data used by the specific model (S21). Next, the learning unit 22 learns the control related to the radio network by the learning model using the received learning data (S22). Furthermore, the learning unit 22 applies the learned learning model to the specific model of the first control system 10.

As described above, in the example embodiments, the first control system such as the Near-RT RIC transmits the specifying data collected for the specific model to the second control system such as the Non-RT RIC as the learning data to be used for the learning model. In the second control system, learning is performed using learning data received from the first control system. As a result, the first control system transfers the data collected from the radio network to the second control system, and the second control system can learn the learning model by the transferred data, so that it is possible to suppress the load of the node that provides the data of the radio network and the transmission path that transmits the data.

### First Example Embodiment

Next, a first example embodiment will be described. In the present example embodiment, an example in which data used in inference by the Near-RT RIC is transferred to the Non-RT RIC as learning data will be described.

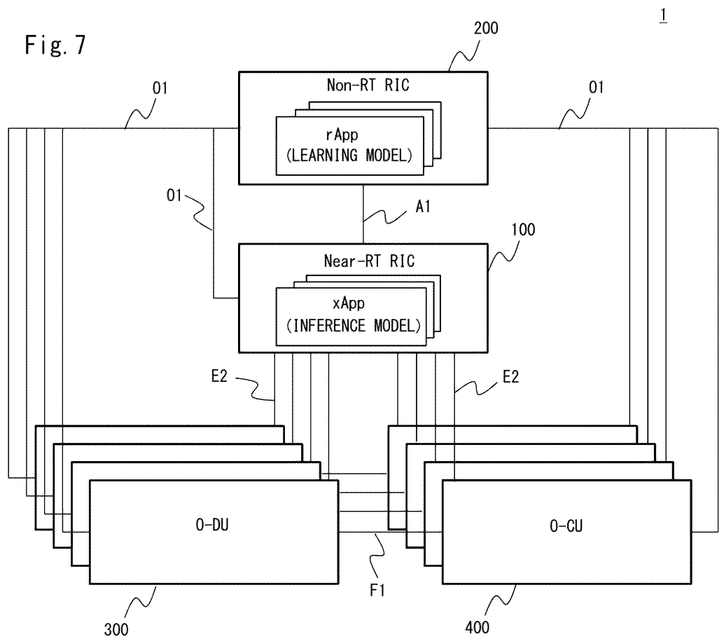

FIG. 7 illustrates a configuration example of a RAN system 1 according to the present example embodiment. As illustrated in FIG. 7, the RAN system 1 includes a Near-RT RIC 100, a Non-RT RIC 200, an O-DU 300, and an O-CU 400.

The Non-RT RIC 200 and the Near-RT RIC 100, and the Non-RT RIC 200 and the E2 node including the O-DU 300 and the O-CU 400 are communicably connected via an O1 interface. The O1 interface is an interface for transmitting and receiving data and messages mainly necessary for operation and management. Note that the interface is a connection interface defined by a communication protocol for transmitting and receiving data and messages, and includes a logical transmission path, a network, a physical transmission path, and a network.

The Non-RT RIC 200 and the Near-RT RIC 100 are communicably connected via an A1 interface. The Near-RT RIC 100 and the E2 node including the O-DU 300 and the O-CU 400 are connected via an E2 interface. The A1 interface and the E2 interface are interfaces for mainly transmitting and receiving data and messages necessary for control. The O-DU 300 and the O-CU 400 are communicably connected via an F1 interface.

The O-DU 300 and the O-CU 400 are notes constituting the RAN and are also referred to as E2 nodes. The RAN is a radio network accessed by user equipment (UE), and is connected to a core network such as a 5G core network (5GC) or an evolved packet core (EPC). The RAN may include an O-RAN remote unit (O-RU) constituting an antenna. The UE is a terminal device that is connected to the RAN and performs radio communication, and may be a mobile phone, a smartphone, a tablet terminal, an Internet of Things (IoT) terminal, or the like. The UE may be an application device such as a robot, a drone, or a self-driving vehicle that implements a function of a terminal.

The O-DU 300 and the O-CU 400 provide a base station function. The base station is, for example, a next generation node B (gNB) or an evolved node B (eNB), but is not limited thereto. Note that the O-DU 300 and the O-CU 400 are examples of nodes that provide the base station function, and may be other network nodes.

The O-DU 300 is a logical node that provides a radio signal control function and a layer 2 control function of the base station. The O-DU 300 accommodates the O-RU and performs control of a radio signal (beam) of an antenna in the O-RU to accommodate the O-RU and protocol processing such as media access control (MAC) or radio link control (RLC) necessary between the O-RU and the O-CU 400.

The O-CU 400 is a logical node that provides a radio resource control function of the base station and a data processing function higher than the layer 2. The O-CU 400 accommodates the O-DU 300 and performs data transmission/reception via the O-DU 300 that accommodates the O-DU, quality of service (QoS) control, cell/UE management, handover control, and protocol processing such as packet data convergence protocol (PDCP), service data adaptation protocol (SDAP), and radio resource control (RRC) necessary between the O-DU 300 and the core network.

The RAN system 1 may include one or more arbitrary numbers of O-DUs 300 and O-CUs 400 as the E2 nodes. That is, a plurality of base stations may be included. The O-DU 300 and the O-CU 400 are not necessarily the same number. The O-DU 300 and the O-CU 400 may be arranged at different places or may be arranged at the same place. In addition, the O-DU 300 and the O-CU 400 may be implemented by different virtual machines operating on the virtualization base of the edge, or the same virtual machine. The O-DU 300 and the O-CU 400 may be a virtualized distributed unit (vDU) and a virtualized central unit (vCU), and may constitute a virtual base station. Note that the O-DU 300 and the O-CU 400 may be physical DUs and CUs. In addition, the E2 node may be a base station apparatus including the functions of the O-DU 300 and the O-CU 400.

The Near-RT RIC 100 is a logical function that controls and optimizes the RAN in near real time. The Near-RT RIC 100 controls the RAN with a short control cycle of, for example, 10 ms or more and less than 1 s. The Near-RT RIC 100 collects and analyzes RAN data from the E2 node including either or both of the O-DU 300 and the O-CU 400 via the E2 interface, and controls the E2 node according to the RAN data. For example, the Near-RT RIC 100 performs control according to the RAN data in accordance with the control policy acquired from the Non-RT RIC 200 via the A1 interface. The control policy is a policy related to control of the RAN, and is, for example, an A1 policy. The A1 policy is guidance for RAN optimization defined in the A1 interface. The RAN data is data collected from either or both of the O-DU 300 and the O-CU 400. The RAN data is radio related data related to radio of the RAN, includes radio quality data and location information for each UE, and may include the number of active UEs for each base station (cell). For example, the radio quality data may be acquired from the O-DU 300, or the information regarding the handover may be acquired from the O-CU 400. The Near-RT RIC 100 is disposed at the same place as either or both of the O-DU 300 and the O-CU 400, or at a place near either or both of the O-DU 300 and the O-CU 400. For example, the Near-RT RIC 100 may be implemented in a virtual machine of the same edge as either or both of the O-DU 300 and the O-CU 400.

Some functions of the Near-RT RIC 100 are implemented by xApp (Near-RT RIC Application). The xApp includes an application for analyzing RAN data, controlling RAN, and the like. For example, the xApp includes an inference model (also referred to as an inference engine) that is a learned model, and analyzes inference data including RAN data and controls the RAN by the inference model. The Near-RT RIC 100 may include a plurality of xApps as needed.

The Non-RT RIC 200 is a logical function that controls and optimizes the RAN in non-real time. The Non-RT RIC 200 controls the RAN with a long control cycle of, for example, 1 s or more. The Non-RT RIC 200 manages a control policy, manages operations of the E2 node including the O-DU 300 and the O-CU 400 and the Near-RT RIC 100, learns (trains) the learning model, updates the inference model, and the like. For example, the Non-RT RIC 200 generates a control policy and notifies the Near-RT RIC 100 of the generated control policy via the A1 interface. In addition, the Non-RT RIC 200 manages and sets configuration information (Configuration) of the E2 node based on data acquired from the E2 node or the Near-RT RIC 100 via the O1 interface. The Non-RT RIC 200 is disposed in a service management and orchestration (SMO) that manages and orchestrates the RAN. The SMO is located at a place remote from the O-DU 300, the O-CU 400, and the Near-RT RIC 100, for example, on a cloud. Note that the Non-RT RIC 200 may include a function of SMO.

Some functions of the Non-RT RIC 200 are implemented by a Non-RT RIC application (rApp). The rApp includes an application that generates a control policy, manages an inference model of the Near-RT RIC 100, and the like. For example, the rApp includes a learning model (also referred to as a learning engine), generates a learning model in which control of the RAN is learned using learning data acquired from the E2 node or the Near-RT RIC 100 via the O1 interface, and applies the generated learned learning model to the xApp of the Near-RT RIC 100. Note that applying a learned learning model to the inference model is also referred to as deployment. The deployment is to place and deploy the model in an execution environment of the application and make the model executable. the non-RT RIC 200 may include a plurality of rApps as necessary.

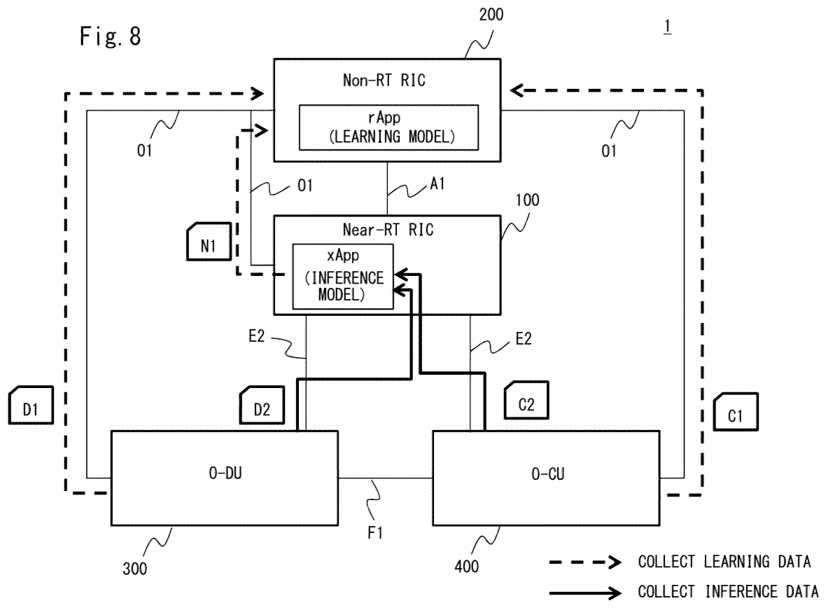

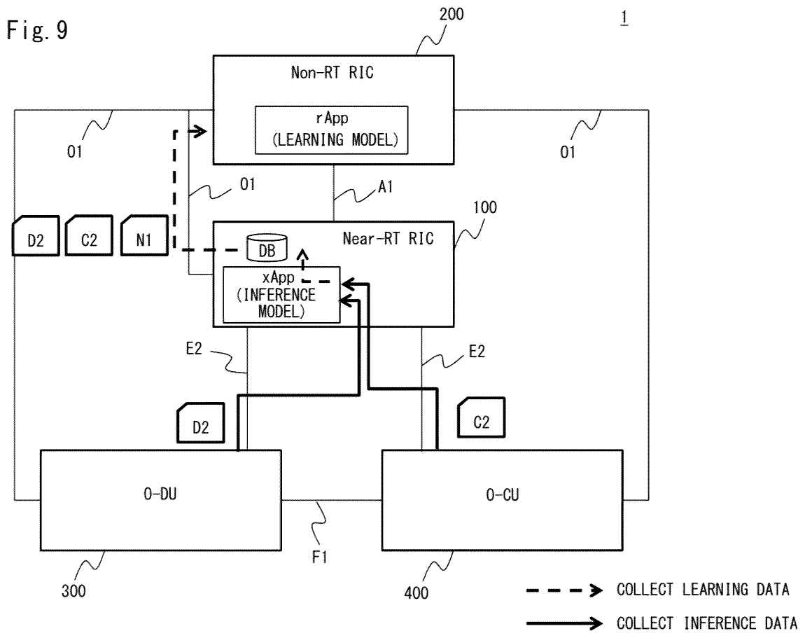

FIG. 8 illustrates a flow of data for inference and learning in the comparative example, and FIG. 9 illustrates a flow of data for inference and learning in the present example embodiment. Note that the arrows illustrated in FIGS. 8 and 9 represent the direction of data collection in view of convenience of description, and do not intend to limit data transmission and reception associated with such data collection.

As illustrated in FIG. 8, in the comparative example, in a case where the learning model (rApp) of the Non-RT RIC 200 performs learning, the Non-RT RIC 200 collects RAN data (D1, C1) as learning data from the O-DU 300 and the O-CU 400 via the O1 interface. In addition, the Near-RT RIC 100 collects RAN data (D2, C2) as inference data from the O-DU 300 and the O-CU 400 via the E2 interface. In the Near-RT RIC 100, the inference model (xApp) performs inference using the collected RAN data, and controls the O-DU 300 and the O-CU 400 according to the inference result. Note that the Near-RT RIC 100 may collect RAN data from either the DU 300 or the O-CU 400 and control either the DU 300 or the O-CU 400. The Near-RT RIC 100 transmits the inferred inference result data (N1) as learning data to the Non-RT RIC 200 via the O1 interface. The learning model of the Non-RT RIC 200 performs learning using the RAN data (D1, C1) collected from the O-DU 300 and the O-CU 400 and the inference result data (N1) collected from the Near-RT RIC 100 as learning data via the O1 interface. Note that the Non-RT RIC 200 may collect RAN data from either the DU 300 or the O-CU 400, similarly to the Near-RT RIC 100. In this example, the RAN data (D1, C1) and the RAN data (D2, C2) are the same data.

In the comparative example, since either or both of the O-DU 300 and the O-CU 400 transmit the RAN data via the two interfaces of the O1 interface and the E2 interface, the communication load of either or both of the O-DU 300 and the O-CU 400 is doubled as compared with the case of transmitting the RAN data via one interface. Then, in the comparative example, since a communication load only for acquiring and collecting learning data occurs in one or both of the O-DU 300 and the O-CU 400, it is necessary to enhance communication resources of one or both of the O-DU 300 and the O-CU 400 for learning to be performed sometimes.

In addition, in the comparative example, since the RAN data from either or both of the O-DU 300 and the O-CU 400 and the inference result data from the Near-RT RIC 100 are transmitted through the O1 interface, the load of the O1 interface is also large. In particular, in a case where the transmission buffers of the O-DU 300 and the O-CU 400 are small, the transmission timing cannot be adjusted, and thus, there is a high possibility that the communication load of the O1 interface increases. Then, in the comparative example, since the communication load is concentrated on the O1 interface at the timing of acquisition and collection of the learning data, it is necessary to enhance the communication resources of the O1 interface for learning to be performed sometimes.

Therefore, in the present example embodiment, in a case where the learning data used by the learning model mounted on the Non-RT RIC 200 is acquired and collected from one or both of the O-DU 300 and the O-CU 400, it is possible to reduce the communication load of one or both of the O-DU 300 and the O-CU 400 and to prevent the concentration of the communication load on the O1 interface.

Specifically, in the present example embodiment, as illustrated in FIG. 9, in a case where the learning model (rAPP) of the Non-RT RIC 200 performs learning, the Near-RT RIC 100 collects RAN data (D2, C2) as inference data via the E2 interface, and the inference model (xApp) performs inference using the collected RAN data. As in the comparative example, the Near-RT RIC 100 may collect RAN data from either the DU 300 or the O-CU 400 and control either the DU 300 or the O-CU 400. In the present example embodiment, the Near-RT RIC 100 accumulates data required for learning from data used for inference in a database (DB) as a log. For example, the collected RAN data (D2, C2) and the inferred inference result data (N1) are accumulated.

The Near-RT RIC 100 transfers the accumulated RAN data (D2, C2) and the inference result data (N1) as learning data to the Non-RT RIC 200 via the O1 interface. For example, the Near-RT RIC 100 effectively uses the timing at which the O1 interface is free to transmit to the Non-RT RIC 200. The learning model of the Non-RT RIC 200 performs learning using the RAN data (D2, C2) and the inference result data (N1) collected from the Near-RT RIC 100 via the O1 interface as learning data.

As a result, in the present example embodiment, as compared with the comparative example, either or both of the O-DU 300 and the O-CU 400 transmit the RAN data only through the E2 interface, so that the load of either or both of the O-DU 300 and the O-CU 400 can be reduced. In addition, in the O1 interface, since data is transmitted only from the Near-RT RIC 100, the load of the O1 interface can also be suppressed.

Note that the comparative example of FIG. 8 and the present example embodiment of FIG. 9 may be implemented in combination. For example, some pieces of the RAN data may be transferred from one or both of the O-DU 300 and the O-CU 400 to the Non-RT RIC 200 via the O1 interface as illustrated in FIG. 8, and other pieces of the RAN data may be transferred from the Near-RT RIC 100 to the Non-RT RIC 200 via the O1 interface as illustrated in FIG. 9.

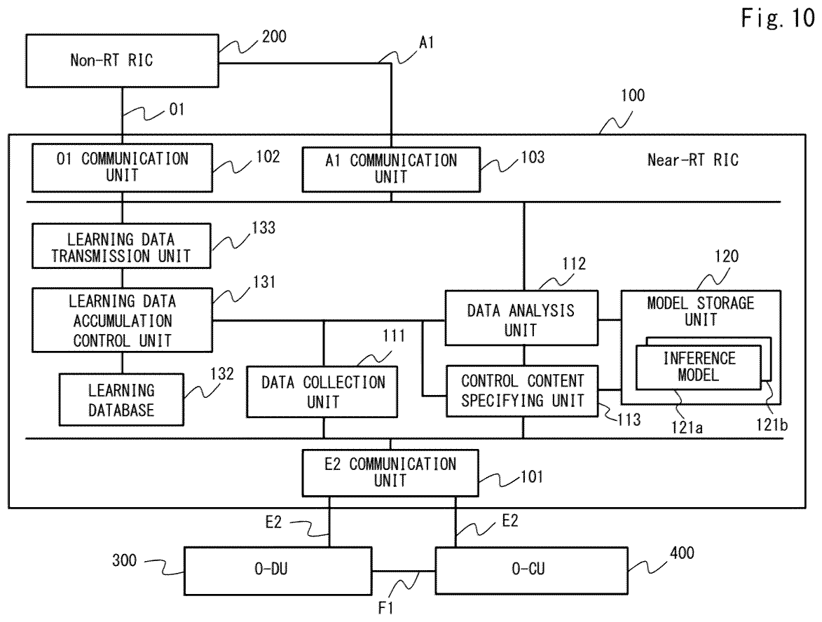

FIG. 10 illustrates a configuration example of the Near-RT RIC 100 according to the present example embodiment. As illustrated in FIG. 10, the Near-RT RIC 100 includes an E2 communication unit 101, an O1 communication unit 102, an A1 communication unit 103, a data collection unit 111, a data analysis unit 112, a control content specifying unit 113, a model storage unit 120, a learning data accumulation control unit 131, a learning database 132, and a learning data transmission unit 133. Note that the configuration is an example, and another configuration may be used as long as the operation according to the present example embodiment described below can be performed. Furthermore, a configuration for realizing a function necessary for the Near-RT RIC 100 may be included.

The E2 communication unit 101 is a communication unit that communicates with the O-DU 300 and the O-CU 400 via the E2 interface. For example, the E2 communication unit 101 transmits and receives various data including the RAN data, control messages, and the like to and from the O-DU 300 and the O-CU 400 according to a communication scheme defined as the E2 interface.

The O1 communication unit 102 is a communication unit that communicates with the Non-RT RIC 200 via the O1 interface. For example, the O1 communication unit 102 transmits and receives various data including learning data, control messages, and the like to and from the Non-RT RIC 200 according to a communication scheme defined as the O1 interface.

The A1 communication unit 103 is a communication unit that communicates with the Non-RT RIC 200 via the A1 interface. For example, the A1 communication unit 103 transmits and receives the control message including various data and a control policy to and from the Non-RT RIC 200 according to a communication scheme defined as the A1 interface.

The data collection unit 111 collects the RAN data from one or both of the O-DU 300 and the O-CU 400 via the E2 interface through the E2 communication unit 101. For example, the data collection unit 111 and the E2 communication unit 101 correspond to the collection unit 11 in FIG. 1. The data collection unit 111 periodically collects the RAN data as inference data used for inference by the inference models of the data analysis unit 112 and the control content specifying unit 113. The data collection unit 111 may instruct any one or both of the O-DU 300 and the O-CU 400 of the data to be collected and the cycle. The data collection unit 111 outputs the collected RAN data to the data analysis unit 112 and the learning data accumulation control unit 131.

The model storage unit 120 stores an inference model 121 used by the data analysis unit 112 and the control content specifying unit 113 for analysis processing and control processing. The inference model 121 is a learned model and is a model that infers control of the E2 node including either or both of the O-DU 300 and the O-CU 400 according to the RAN data. The inference model 121 is, for example, a model capable of analyzing and predicting time-series data. The inference model 121 may be a convolutional neural network (CNN), a recurrent neural network (RNN), a long-short term model (LSTM), or another neural network. The inference model 121 is not limited to the neural network, and may be another machine learning model. The model storage unit 120 may store a plurality of inference models 121. For example, the model storage unit 120 stores an inference model 121a for data analysis used by the data analysis unit 112 and an inference model 121b for control content specification used by the control content specifying unit 113. The inference model 121a is an analysis model that analyzes data, and the inference model 121b is a specific model that specifies control contents.

The data analysis unit 112 analyzes the RAN data collected by the data collection unit 111, that is, the inference data. The function of the data analysis unit 112 may be realized by executing xApp for data analysis processing, that is, radio analysis processing. The data analysis unit 112 analyzes the RAN data using the inference model 121a for data analysis stored in the model storage unit 120. The data analysis unit 112 inputs the collected RAN data to the inference model 121a and analyzes the RAN data. The data analysis unit 112 outputs an analysis result obtained by analyzing the RAN data, that is, an inference result, as radio analysis information. For example, in a case where the RAN data is radio quality data, the inference model 121a predicts future radio quality from input radio quality data, and outputs a prediction result of the radio quality as radio analysis information. The data analysis unit 112 outputs the radio analysis information to the control content specifying unit 113 and the learning data accumulation control unit 131.

The control content specifying unit 113 specifies the control content of the E2 node including one or both of the O-DU 300 and the O-CU 400 based on the analysis result of the RAN data analyzed by the data analysis unit 112, and performs control on the E2 node. The function of the control content specifying unit 113 may be realized by executing xApp for specifying the control content, that is, for radio control processing. In addition, the control content specifying unit 113 may control the E2 node according to the control policy notified via the A1 interface through the A1 communication unit 103. The control content specifying unit 113 specifies the control content (control information) of the E2 node using the inference model 121b for specifying the control content stored in the model storage unit 120. The control content specifying unit 113 inputs the radio analysis information, which is an analysis result of the data analysis unit 112, to the inference model 121b and specifies control content corresponding to the radio analysis information. For example, a plurality of control contents may be inferred, and the control contents to be used for control may be specified according to the control policy. The control content specifying unit 113 outputs a specifying result of specifying the control content, that is, an inference result, as the radio control information. For example, in a case where the data analysis unit 112 predicts the future radio quality, the radio intensity, the modulation scheme, and the like to be set in the E2 node are specified according to the predicted radio quality, and control information to be set in the corresponding E2 node is output as the radio control information. The control content specifying unit 113 transmits radio control information indicating the specified control content to one or both of the O-DU 300 and the O-CU 400 via the E2 interface through the E2 communication unit 101. Further, the control content specifying unit 113 outputs the radio control information to the learning data accumulation control unit 131.

The learning database 132 is a learning data accumulation unit that accumulates learning data. The learning data accumulation control unit 131 controls the learning data accumulated in the learning database 132. Specifically, the learning data accumulation control unit 131 acquires and selects data necessary for learning, and accumulates the acquired and selected data in the learning database 132. In addition, the learning data accumulation control unit 131 performs integration processing to shape the accumulated data for transmission. It can also be said that the learning data accumulation control unit 131 includes a learning data acquisition unit, a learning data selection unit, and a learning data integration unit.

For example, the learning data accumulation control unit 131 starts accumulation control of learning data according to an instruction from the Non-RT RIC 200. The learning data accumulation control unit 131 acquires the RAN data which is the inference data collected by the data collection unit 111, the radio analysis information generated by the data analysis unit 112, and the radio control information generated by the control content specifying unit 113, and selects, that is, extracts the learning data from among the collected and acquired data. The learning data accumulation control unit 131 may collect and acquire all of the RAN data, the radio analysis information, and the radio control information, or may collect and acquire any or arbitrarily selected data. The radio analysis information and the radio control information are also inference result data inferred by the inference model. The learning data to be selected is data used for learning by the learning model of the Non-RT RIC 200, and may be instructed from the Non-RT RIC 200 or may be determined in advance. For example, the learning data to be selected may be determined for each learning model or application. The learning data accumulation control unit 131 may narrow down the learning data under a predetermined condition. For example, in a case where the RAN data includes the location information of the UE, the learning data may be narrowed down based on the location information. For example, the RAN data included in a specific area for which radio quality or the like is desired to be acquired may be extracted. In addition, RAN data included in other areas may be extracted except for the already-acquired area.

Note that all collected and acquired RAN data, radio analysis information, and radio control information may be accumulated, and learning data to be transmitted may be selected from among the accumulated data at the time of transmission to the Non-RT RIC 200.

The learning data accumulation control unit 131 accumulates the selected learning data in the learning database 132. For example, the learning data may be accumulated in a predetermined format, or the learning data may be accumulated in a format instructed from the Non-RT RIC 200. The learning data accumulation control unit 131 may accumulate the RAN data collected from the plurality of O-DUs 300 and the plurality of O-CUs 400. In addition, a plurality of pieces of radio analysis information and a plurality of pieces of radio control information analyzed and controlled for the plurality of O-DUs 300 and the plurality of O-CUs 400 may be accumulated.

After starting the accumulation of the learning data, the learning data accumulation control unit 131 ends the accumulation in a predetermined case. For example, in a case where the timing, the predetermined timing, the instructed period, or the predetermined period instructed from the Non-RT RIC 200 ends, or in a case where the instructed amount or the predetermined amount of data is accumulated, the accumulation of the learning data may end. Once the accumulation is completed, the learning data accumulation control unit 131 integrates the learning data accumulated in the learning database 132 into a transmission file. The integration of the learning data includes integrating the RAN data of the plurality of O-DUs 300 and the plurality of O-CUs 400, and integrating the RAN data of the plurality of O-DUs 300 and the plurality of O-CUs 400, the plurality of pieces of radio analysis information, and the plurality of pieces of radio control information. The integrated file may be referred to as a learning data file or integrated data.

The learning data accumulation control unit 131 may process or shape the data as necessary in a case where integrating the learning data. For example, the learning data accumulation control unit 131 may reduce the data amount by compressing the learning data. The data before the integration may be compressed, or the data after the integration may be compressed. For example, the learning data accumulation control unit 131 may reduce data by dimensionality reduction. In the dimensionality reduction, multi-dimensional data is dropped into information of less dimensions within a range not affecting learning of the learning model. For example, the feature amount of the learning data input to the learning model at the time of learning is reduced within a range in which accuracy of data analysis (radio analysis) and control content specification (radio control) is not degraded. In addition, deduplication for eliminating duplicated data such as data of the same area may be performed, or data may be compressed using predetermined encoding. Not limited to the compression, the integrated data may be divided into a plurality of pieces of data. For example, a plurality of learning data files may be transmitted.

The learning data transmission unit 133 transmits the learning data integrated by the learning data accumulation control unit 131, that is, the learning data file to the Non-RT RIC 200 via the O1 interface through the O1 communication unit 102. For example, the learning data transmission unit 133 and the O1 communication unit 102 correspond to the transmission unit 12 in FIG. 1. The learning data transmission unit 133 may control a transmission timing and a transfer rate of the learning data file. The learning data transmission unit 133 may control the transmission timing and the transfer rate according to an instruction from the Non-RT RIC 200, or may control the transmission timing and the transfer rate according to the communication status of the O1 interface. For example, in a case where the transmission band of the O1 interface has a free space, the learning data file may be transmitted, and in a case where the transmission band does not have a free space, the transmission timing of the learning data file may be delayed. The learning data file may be transmitted in a case where the free transmission band is larger than a predetermined threshold value, or the learning data file may be transmitted in a case where the free transmission band is larger than a band necessary for a file size to be transmitted. In addition, the transfer rate may be controlled according to the free transmission band. The free transmission band may be a band acquired by monitoring the communication amount of the O1 interface by the O1 communication unit 102, or may be a band predicted from the monitoring result.

In addition, in a case where transmitting a plurality of pieces of learning data, that is, a plurality of learning data files, the learning data transmission unit 133 may control the transmission order of the learning data files. For example, the data may be transmitted in the order according to the priority of the learning data included in the learning data file. The priority may be set according to the order of data used for learning by the learning model and whether the data is essential for learning of the learning model or arbitrary data, or may be designated from the Non-RT RIC 200. The transmission order of the learning data file may be determined based on the highest priority among the priorities of the learning data included in the learning data file. In addition, the learning data may be integrated for each priority of the learning data, and the transmission order of the learning data file may be determined based on the priority of the integrated learning data file. In addition, in a case where the learning data is integrated and transmitted for each learning model, the learning data file may be transmitted in an order according to the priority of the learning model (application). For example, the transmission order of the learning data file may be determined based on the importance level of the application, the urgency level of learning of the learning model, and the like. In addition, in a case where there is traffic to be transmitted via the O1 interface in addition to the learning data by another application or the like, the transmission timing and the transmission order may be adjusted between the traffic. For example, transmission scheduling may be performed in consideration of a desired delivery time among traffic for a plurality of applications.

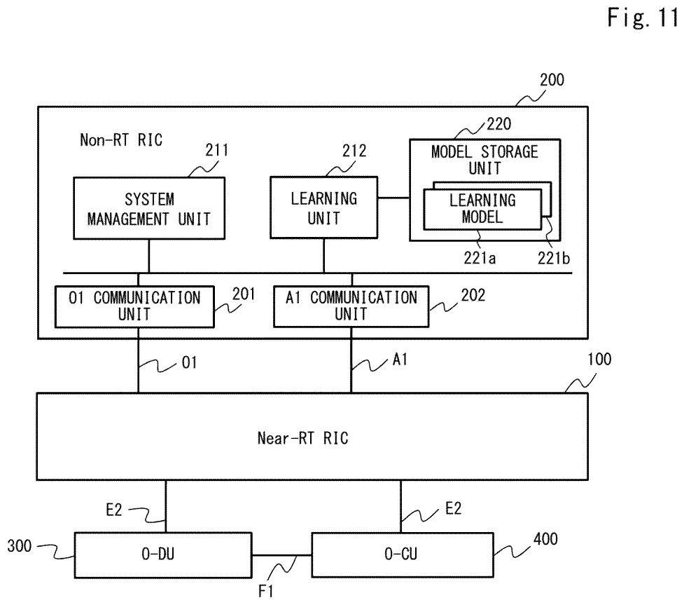

FIG. 11 illustrates a configuration example of the Non-RT RIC 200 according to the present example embodiment. As illustrated in FIG. 11, the Non-RT RIC 200 includes an O1 communication unit 201, an A1 communication unit 202, a system management unit 211, a learning unit 212, and a model storage unit 220. Note that the configuration is an example, and another configuration may be used as long as the operation according to the present example embodiment described below can be performed. Furthermore, a configuration for realizing a function necessary for the Non-RT RIC 200 may be included.

The O1 communication unit 201 is a communication unit that communicates with the Near-RT RIC 100 via the O1 interface. For example, the O1 communication unit 201 transmits and receives various data including learning data, control messages, and the like to and from the Near-RT 100 according to a communication scheme defined as the O1 interface. In addition, it is also possible to transmit and receive necessary data and control messages to and from the O-DU 300 and the O-CU 400 via the O1 interface.

The A1 communication unit 202 is a communication unit that communicates with the Near-RT RIC 100 via the A1 interface. For example, the A1 communication unit 202 transmits and receives control messages including various data and control policies to and from the Near-RT RIC 100 according to a communication scheme defined as the A1 interface.

The system management unit 211 manages the setting and operation of the RAN system including the O-DU 300, the O-CU 400, and the Near-RT RIC 100. The function of the system management unit 211 may be realized by executing rApp for system management processing. For example, the system management unit 211 is a policy generation unit that generates a control policy. The system management unit 211 may generate the control policy based on an instruction input from an operator or an external apparatus, or may generate the control policy based on data acquired from any or all of the O-DU 300, the O-CU 400, and the Near-RT RIC 100. The system management unit 211 notifies the Near-RT RIC 100 of the generated control policy through the A1 interface via the A1 communication unit 202.

The model storage unit 220 stores a learning model 221 for constructing the inference model 121 of the Near-RT RIC 100. The learning model 221 is the same model as the inference model 121, and is, for example, a model that performs learning so as to be able to analyze and predict time-series data. Similarly to the Near-RT RIC 100, the model storage unit 220 can store a plurality of learning models 221, and stores, for example, a learning model 221a for data analysis and a learning model 221b for specifying a control content.

The learning unit 212 performs machine learning using learning data received from the Near-RT RIC 100 via the O1 interface through the O1 communication unit 201, that is, the learning data file. For example, the learning unit 212 corresponds to the learning unit 22 in FIG. 2. The function of the learning unit 212 may be realized by executing an rApp for learning processing. It can also be said that the learning unit 212 includes a reception unit that receives the learning data file from the Near-RT RIC 100 via the O1 interface. For example, the O1 communication unit 201 and the learning unit 212 also correspond to the reception unit 21 in FIG. 2. In a case where the received learning data file is compressed or divided, the learning unit 212 performs decompression or combination processing as necessary. The learning unit 212 performs machine learning such as deep learning to generate a learned learning model 221. The learning unit 212 inputs the learning data file to the learning model 221a for data analysis of the model storage unit 220 and the learning model 221b for specifying a control content of the model storage unit 220, and trains each model. Data processing necessary for inputting the received learning data fill to the learning models 221a and 221b may be performed. In addition, similarly to the Near-RT RIC 100, a learning unit for data analysis and a learning unit for specifying control contents may be provided. The learning data of the received learning data file includes RAN data of either or both of the O-DU 300 and the O-CU 400 and inference result data (radio analysis information and radio control information) of the Near-RT RIC 100, and the analysis and control according to the RAN data can be learned by using these pieces of data. That is, it is possible to perform training with high accuracy by using the RAN data before control input to the inference model, the data of the inference result output from the inference model, and the RAN data after control based on the inference result as learning data. The learning data may be any one of the RAN data, radio analysis information, and radio control information. The learning unit 212 stores the learned learning models 221a and 221b in the model storage unit 220, transmits the learned learning models 221a and 221b to the Near-RT RIC 100, and applies the learning models to the inference models 121a and 121b.

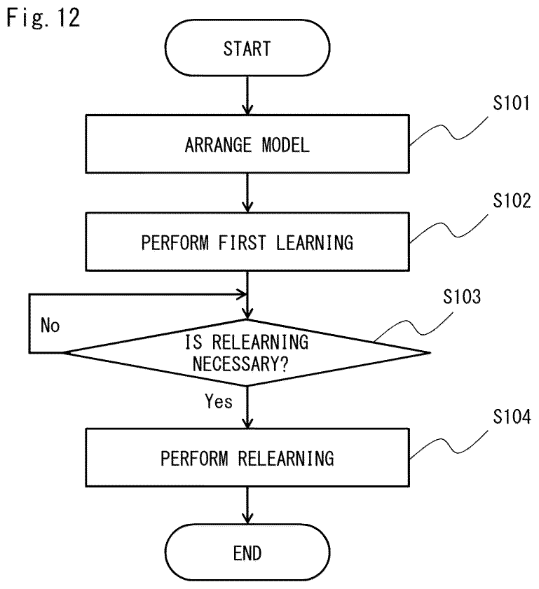

FIG. 12 illustrates an outline of learning processing in the RAN system 1 according to the present example embodiment. As illustrated in FIG. 12, first, a learning model is prepared and arranged in the RAN system 1 (S101). For example, in an external learning apparatus, a learned model trained (learned) by simulation is generated, the generated model is stored in the model storage unit 120 of the Near-RT RIC 100 as an inference model (xApp), and the same model is stored in the model storage unit 220 of the Non-RT RT 200 as a learning model (rApp). Not limited to the simulation, a model on which a predetermined algorithm is mounted may be arranged in the Near-RT RIC 100 as an inference model, and the same model may be arranged in the Non-RT RIC 200 as a learning model.

Next, the RAN system 1 performs first learning at the time of system introduction (S102). At the time the system is introduced, the inference model (xApp) of the Near-RT RIC 100 is subjected to a main operation or a test operation in the real environment to collect learning data. Further, the learning data is transferred from the Near-RT RIC 100 to the Non-RT RIC 200, and the learning model (rApp) is trained by the transferred learning data. For example, learning data for one hour may be collected and used for training. The learned learning model learned by the first learning is applied to the Near-RT RIC 100 as an inference model. Note that since there is little influence on the load of the system in the initial learning, the Non-RT RIC 200 may collect the RAN data from either or both of the O-DU 300 and the O-CU 400 via the O1 interface as in the comparative example.

Next, the RAN system 1 determines whether relearning is necessary (S103), and in a case where the relearning is necessary, the RAN system 1 performs second and subsequent relearning (S104). For example, the Non-RT RIC 200 determines that relearning is necessary and performs relearning in a case where an instruction is input from an operator or an external apparatus, in a case where an environment of a site including the UE changes, in a periodic timing, in a case where accuracy of the inference model decreases, or the like. The change in environment may be detected from a change in radio quality, or a signal indicating a change in environment such as a layout change may be input. The accuracy of the inference model may be determined from the inference result of the inference model, the RAN data, and the like. In the relearning, the Near-RT RIC 100 uses the inference model (xApp) previously trained and applied, and collects learning data during actual operation while operating the inference model in the actual environment. Further, the learning data is transferred from the Near-RT RIC 100 to the Non-RT RIC 200, and the learning model (rApp) is trained by the transferred learning data. For example, learning data for one hour may be collected and used for training. The learned learning model learned by relearning is applied to the Near-RT RIC 100 as an inference model. Thereafter, the relearning is repeatedly performed in S103 and S104.

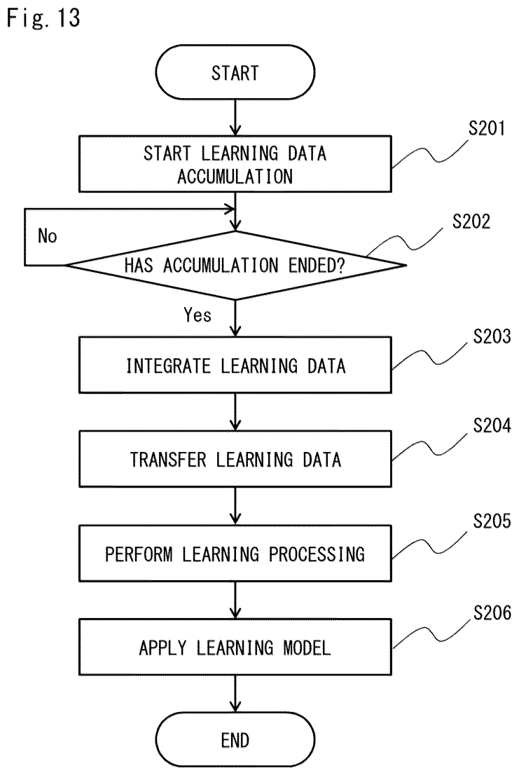

FIG. 13 illustrates an operation example of the learning processing in the RAN system 1 according to the present example embodiment. For example, FIG. 13 is an example of the learning processing in the relearning (S104) illustrated in FIG. 12, but may be applied to the learning processing in the first learning (S102).

As illustrated in FIG. 13, the Near-RT RIC 100 starts accumulating learning data (S201). For example, the learning unit 212 instructs the Near-RT RIC 100 to start learning. The learning data accumulation control unit 131 starts accumulation of the learning data in the learning database 132 in response to an instruction from the Non-RT RIC 200.

Subsequently, the Near-RT RCI 100 determines whether the accumulation of the learning data has ended (S202), and integrates the learning data in a case where the accumulation has ended (S203). For example, once the period instructed from the Non-RT RIC 200 ends, the learning data accumulation control unit 131 integrates the learning data accumulated in the learning database 132 into the learning data file.

Subsequently, the Near-RT RIC 100 transfers the learning data file to the Non-RT RIC 200 (S204). For example, the learning data transmission unit 133 transfers the integrated learning data file to the Non-RT RIC 200 at a timing instructed from the Non-RT RIC 200 or in a case where the O1 interface is available.

Subsequently, the Non-RT RIC 200 performs learning processing of the learning model using the received learning data file (S205). Upon receiving the learning data file from the Near-RT RIC 100, the learning unit 212 trains the learning models 221a and 221b using the learning data included in the received learning data file. Once the learning is completed, the learning unit 212 stores the learned learning models 221a and 221b in the model storage unit 220.

Subsequently, the Non-RT RIC 200 applies the learned learning model to the Near-RT RIC 100 (S206). The learning unit 212 transmits the learned learning models 221a and 221b stored in the model storage unit 220 to the Near-RT RIC 100. The data analysis unit 112 and the control content specifying unit 113 update the inference models 121a and 121b of the model storage unit 120 using the received learning models 221a and 221b. The Near-RT RIC 100 performs the data analysis and control using the updated inference models 121a and 121b.

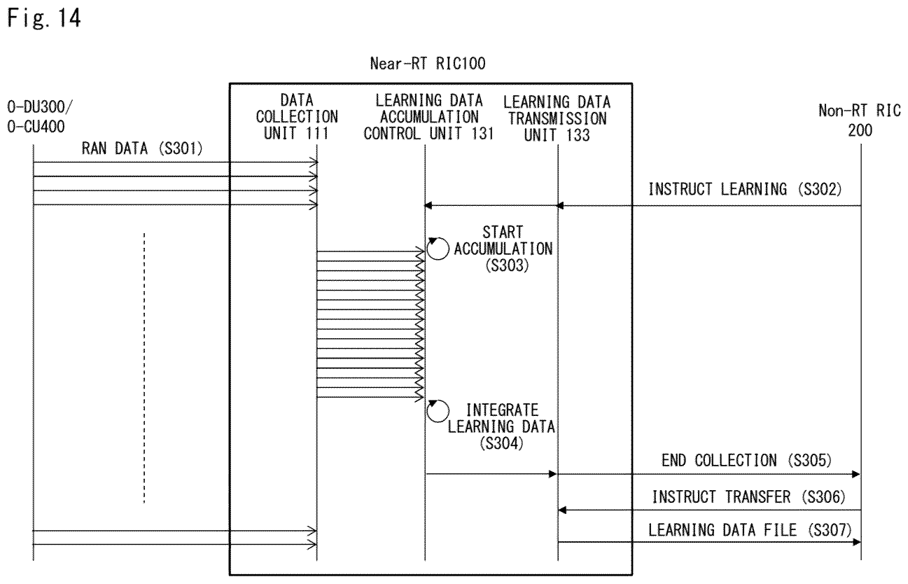

FIG. 14 illustrates a sequence diagram of learning processing in the RAN system 1 according to the present example embodiment. For example, FIG. 14 illustrates operations from accumulation to transfer of the learning data illustrated in FIG. 13 (S201 to S204).

As illustrated in FIG. 14, the Near-RT RIC 100 collects RAN data from either or both of the O-DU 300 and the O-CU 400 (S301). The data collection unit 111 repeatedly collects the RAN data from one or both of the O-DU 300 and the O-CU 400 via the E2 interface. For example, the data collection unit 111 may instruct one or both of the O-DU 300 and the O-CU 400 of data and a cycle to be collected, and one or both of the O-DU 300 and the O-CU 400 may transmit data according to the instruction, or one or both of the O-DU 300 and the O-CU 400 may transmit data according to predetermined data and cycle. In addition, the data analysis unit 112 analyzes the collected RAN data to generate radio analysis information, and the control content specifying unit 113 infers the radio control information according to the radio analysis information. The control content specifying unit 113 transmits the radio control information to one or both of the O-DU 300 and the O-CU 400 via the E2 interface, and controls the operation of one or both of the O-DU 300 and the O-CU 400. The processing of S302 to S307 is performed in parallel with the repetition of the collection and control of the RAN data in S301. That is, the Near-RT RIC 100 accumulates and transfers the learning data while collecting the inference data and performing control by the inference model.

First, the Non-RT RIC 200 transmits a learning instruction message to the Near-RT RIC 100 (S302). The learning unit 212 transmits a learning instruction message to the Near-RT RIC 100 via the O1 interface in response to an instruction from an operator, a change in environment, or the like. The learning instruction message is a message instructing start of collection (accumulation) of learning data for learning of the learning model. For example, the learning instruction message includes a target learning model and a learning data collection period. The target learning model indicates identification information for identifying a learning model (learning engine) to be learned, and the learning data collection period indicates a time at which collection of learning data (training data) starts and a time at which the collection ends. The learning instruction message is not limited to the target learning model, and may include information for identifying the learning data to be collected. The learning data collection period may designate a length of time for collecting the learning data. The learning instruction message is not limited to the learning data collection period, and may include a cycle of collecting the learning data. The target learning model and the learning data collection period may be set in advance or may be set by an operator. For example, in a case where a change in the environment is detected, the target learning model and the learning data collection period may be set according to the change in the environment. In a case where the radio quality changes, the learning model of the application corresponding to the place of the changed radio quality may be determined as the target learning model. The learning instruction message may be transmitted via the O1 interface or may be transmitted via the A1 interface. In the Near-RT RIC 100, the learning data transmission unit 133 receives the learning instruction message via the O1 or A1 interface, and the learning data accumulation control unit 131 acquires the received learning instruction message.

Subsequently, once the learning data collection period designated by the received learning instruction message starts, the Near-RT RIC 100 starts accumulating learning data (S303). The learning data accumulation control unit 131 selects learning data necessary for learning of the target learning model designated by the learning instruction message. For example, the learning model and the learning data are set in advance in association with each other, and the learning data corresponding to the target learning model designated by the learning instruction message is specified. In addition, in a case where learning data to be collected is designated by the learning instruction message, the designated learning data is specified as data to be accumulated. The learning data accumulation control unit 131 selects (extracts) the specified learning data from any one or all of the RAN data collected by the data collection unit 111, the radio analysis information generated by the data analysis unit 112, and the radio control information generated by the control content specifying unit 113, and accumulates the selected learning data in the learning database 132. Necessary data may be accumulated every time the data collection unit 111 collects the RAN data, every time the data analysis unit 112 generates the radio analysis information, and every time the control content specifying unit 113 generates the radio control information. In a case where the learning data collection cycle is designated by the learning instruction message, the data may be accumulated according to the designated cycle. Note that the Near-RT RIC 100 may spontaneously start accumulating the learning data without receiving the learning instruction message from the Non-RT RIC 200. In this case, predetermined learning data may be accumulated in a predetermined period.

Subsequently, once the learning data collection period designated by the learning instruction message ends, the Near-RT RIC 100 integrates the learning data (S304). The learning data accumulation control unit 131 shapes the learning data accumulated in the learning database 132 and integrates the data into one learning data file. For example, the formats of the learning model and the learning data file may be set in advance in association with each other, and the learning data may be shaped and integrated into the learning data file in accordance with the format corresponding to the target learning model designated by the learning instruction message. A format may be designated by the learning instruction message, and the learning data may be integrated according to the designated format. Further, the integrated learning data file may be compressed as necessary. For example, a compression scheme such as dimensionality reduction may be indicated by the learning instruction message, and compression may be performed by the indicated compression scheme, or compression may be performed by a compression scheme corresponding to the target learning model designated by the learning instruction message.

Subsequently, the Near-RT RIC 100 transmits a collection end message to the Non-RT RIC 200 (S305). Once the learning data is integrated, the learning data transmission unit 133 transmits a collection end message to the Non-RT RIC 200 via the O1 interface. The collection end message is a message notifying that the learning data has been prepared, that is, that the collection (accumulation) of the learning data has ended. The collection end message may include a target learning model, similarly to the learning instruction message. Note that the collection end message may be transmitted via the O1 interface or may be transmitted via the A1 interface. In the Non-RT RIC 200, the learning unit 212 receives the collection end message via the O1 or A1 interface.

Subsequently, the Non-RT RIC 200 transmits a transfer instruction message to the Near-RT RIC 100 (S306). Upon receiving the collection end message, the learning unit 212 transmits the transfer instruction message to the Near-RT RIC 100 via the O1 interface. The transfer instruction message is a message instructing transfer of the collected learning data. For example, the transfer instruction message includes timing and a bit rate. The timing indicates a transmission timing of the learning data, and may be a transmission time or the like. The bit rate indicates a transmission bit rate (bps) of the learning data. The transfer instruction message may include the target learning model, similarly to the learning instruction message. Note that the transfer instruction message may be transmitted via the O1 interface or may be transmitted via the A1 interface. In the Near-RT RIC 100, the learning data transmission unit 133 receives the transfer instruction message via the O1 or A1 interface.

Subsequently, the Near-RT RIC 100 transmits the learning data file to the Non-RT RIC 200 (S307). At the timing designated by the received transfer instruction message, the learning data transmission unit 133 transmits the integrated learning data file to the Non-RT RIC 200 via the O1 interface at the bit rate designated by the transfer instruction message. For example, the learning data file may be transmitted in a case where the transmission band of the O1 interface is free after the designated timing. Note that the learning data file may be transmitted via the O1 interface or may be transmitted via the A1 interface. For example, in a case where the transmission band of the O1 interface is not open, transmission may be performed via the A1 interface. Note that the Near-RT RIC 100 may voluntarily transmit the learning data file without receiving the transfer instruction from the Non-RT RIC 200. The learning data file may be transmitted at a timing the accumulation of the learning data is completed and the learning data file is generated or at a predetermined timing.

As described above, in the present example embodiment, for example, once receiving a learning instruction, the Near-RT RIC accumulates, as a log, data required for learning from among data used in inference by the inference model in parallel with inference by the inference model including the radio analysis and radio control. Further, after the log collection, the data accumulated in the Non-RT RIC is transmitted from the Near-RT RIC via the O1 interface by effectively using, for example, a timing at which the O1 interface is vacant, and the learning model is learned by the Non-RT RIC. As a result, since a communication load only for acquiring and collecting learning data does not occur, the communication load of either or both of the O-DU and the O-CU can be reduced, and necessary communication resources can be reduced. In addition, for example, since the Non-RT RIC can collect the learning data by effectively using the timing the O1 interface is free, the communication load on the O1 interface can be distributed, and the necessary communication resources of the O1 interface can be reduced.

### Second Example Embodiment

Next, a second example embodiment will be described. In the present example embodiment, an example of performing learning in the Near-RT RIC will be described. Note that the present example embodiment can be implemented in combination with the first example embodiment, and may be implemented by appropriately using the configuration of the first example embodiment.

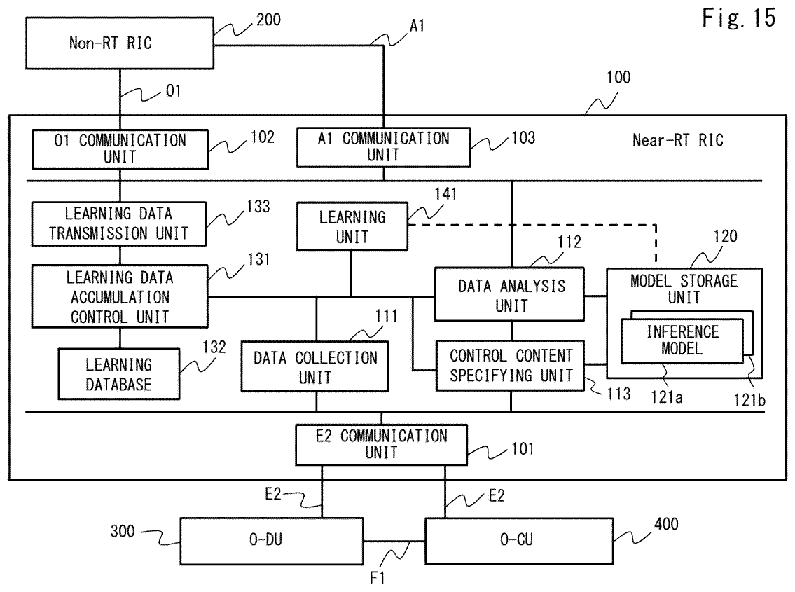

FIG. 15 illustrates a configuration example of the Near-RT RIC 100 according to the present example embodiment. For example, as illustrated in FIG. 15, the Near-RT RIC 100 according to the present example embodiment includes a learning unit 141 in addition to the configuration of the first example embodiment. Other configurations are similar to those of the first example embodiment.

The learning unit 141 performs learning using the inference data and applies the learned learning model to the inference model. The function of the learning unit 141 may be realized by executing xApp for learning processing. Similarly to the learning unit 212 of the Non-RT RIC 200, the learning unit 141 trains the learning model by using any one or all of the RAN data collected by the data collection unit 111, the radio analysis information analyzed by the data analysis unit 112, and the radio control information specified by the control content specifying unit 113. The learning unit 141 may acquire necessary data from the data collection unit 111, the data analysis unit 112, and the control content specifying unit 113, or may acquire necessary data from the learning database 132. The learning unit 141 learns some of the inference models 121 stored in the model storage unit 120. The learning may be performed for either the inference model 121a or the inference model 121b. For example, in a case where it is possible to perform learning limited to a specific cell as in radio analysis such as time series analysis of a signal-to-interference plus noise power ratio (SINR), learning can be performed with relatively light processing, and thus, learning is performed by the learning unit 141 of the Near-RT RIC 100. For example, the learning unit 141 generates a learning model in which the radio analysis is learned by the SINR of the specific cell, and updates the inference model 121a of the model storage unit 120 with the generated learned learning model.

In this manner, learning may be performed by the Near-RT RIC, and the learned learning model may be applied to the inference model inside the Near-RT RIC. As a result, since inference and learning can be performed inside the Near-RT RIC, learning can be performed at high speed, and the load of the O1 interface and the load of the Non-RT RIC can be reduced.

### Third Example Embodiment

Next, a third example embodiment will be described. In the present example embodiment, an example of adjusting the collection frequency of data and the time granularity of data to be transferred according to a change in data to be collected will be described. Note that the present example embodiment can be implemented in combination with any one of the first and second example embodiments, and may be implemented by appropriately using the configuration of any one of the first and second example embodiments.

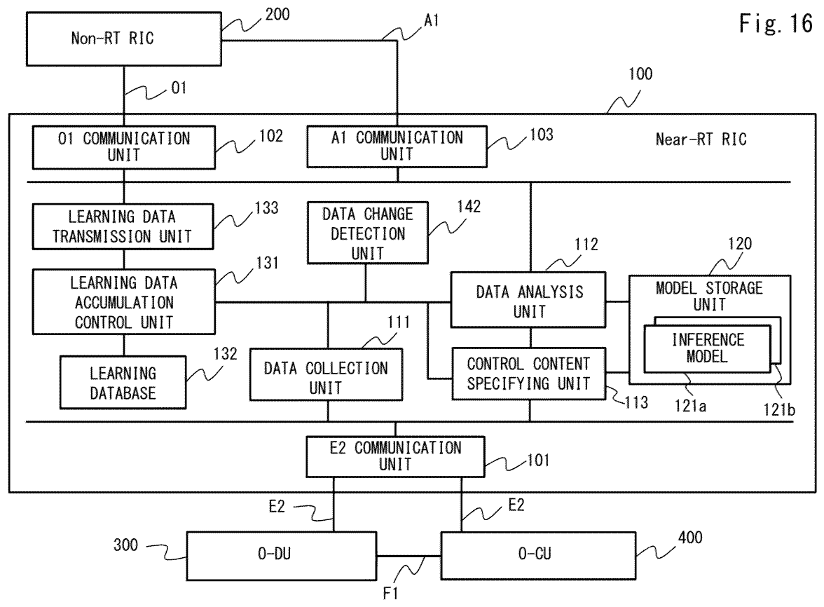

FIG. 16 illustrates a configuration example of the Near-RT RIC 100 according to the present example embodiment. For example, as illustrated in FIG. 16, Near-RT RIC 100 according to the present example embodiment includes a data change detection unit 142 in addition to the configuration of the first example embodiment. Other configurations are similar to those of the first example embodiment.

The data change detection unit 142 detects a change in the RAN data acquired from one or both of the O-DU 300 and the O-CU 400. For example, the change magnitude of the radio quality data, the moving speed of the UE, and the like are detected from the location information of the UE. Note that the function of the data change detection unit 142 may be included in the data analysis unit 112 or another xApp. For example, the data analysis unit 112 may output radio analysis information including a detection result of a change in data.

In the present example embodiment, the data collection unit 111 adjusts the data collection frequency according to the detection result of the data change detection unit 142. For example, the data collection unit 111 adjusts the collection frequency from one or both of the O-DU 300 and the O-CU 400 according to the intensity of the change in the time series of the radio quality data and the moving speed of the UE. As the change in the radio quality data increases, the data collection frequency may be increased, that is, the data collection interval may be shortened, and as the change in the radio quality data decreases, the data collection frequency may be decreased, that is, the data collection interval may be lengthened. In addition, as the moving speed of the UE increases, the data collection frequency may be increased, that is, the data collection interval may be shortened, and as the moving speed of the UE decreases, the data collection frequency may be decreased, that is, the data collection interval may be lengthened.

In addition, the learning data accumulation control unit 131 may adjust the time granularity of the data accumulated in the learning database 132, that is, the time granularity of the data transferred as the learning data according to the detection result of the data change detection unit 142. For example, the learning data accumulation control unit 131 adjusts the time granularity of the data to be accumulated and transferred according to the severity of the change in the time series of the radio quality data and the moving speed of the UE. For example, the time granularity of data can be made coarse by reducing the number of data per unit time. As the change in the radio quality data becomes smaller, the time granularity of the data may be coarser, that is, the interval of the time series data may be longer. As the moving speed of the UE is slower, the time granularity of the data may be coarser, that is, the interval of the time series data may be longer.

In this manner, in a case where data is collected by the Near-RT RIC, the collection frequency of data and the time granularity of data to be transferred may be adjusted according to a change in data to be collected. By adjusting the data collection frequency, it is possible to reduce the load of either or both of the O-DU and the O-CU and the load of the E2 interface. In addition, by adjusting the time granularity of the data to be transferred, the load of the O1 interface can be further reduced.

### Fourth Example Embodiment

Next, a fourth example embodiment will be described. In the present example embodiment, an example of selecting data to be accumulated and transferred according to a change in environment will be described. Note that the present example embodiment can be implemented in combination with any of the first to third example embodiments, and may be implemented by appropriately using any of the configurations of the first to third example embodiments.

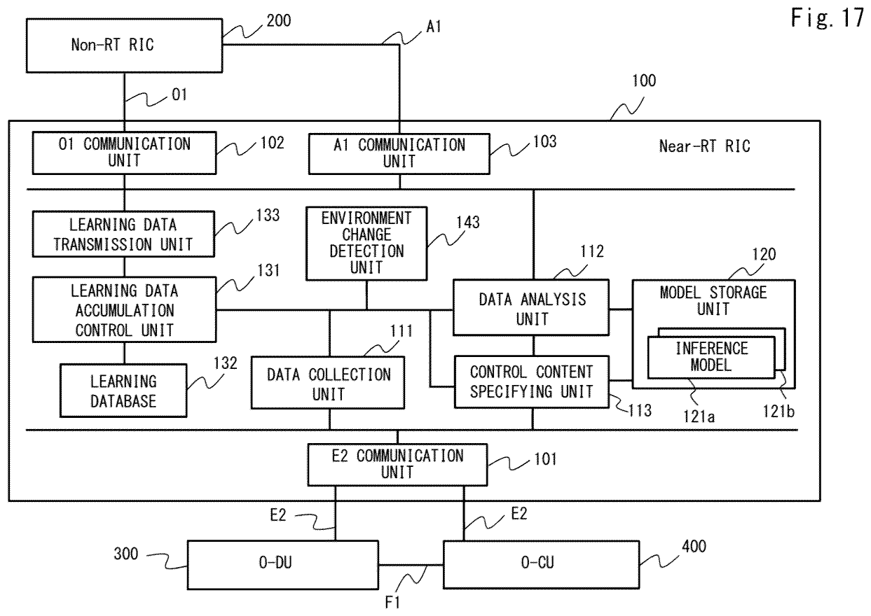

FIG. 17 illustrates a configuration example of the Near-RT RIC 100 according to the present example embodiment. For example, as illustrated in FIG. 17, the Near-RT RIC 100 according to the present example embodiment includes an environment change detection unit 143 in addition to the configuration of the first example embodiment. Other configurations are similar to those of the first example embodiment.

The environment change detection unit 143 detects a change in the environment based on the RAN data acquired from either or both of the O-DU 300 and the O-CU 400. The change in environment is a change in a radio environment of the UE. For example, it is a change in the radio environment that becomes a factor that the learning of the learning model becomes necessary, and is a change in the radio environment caused by a layout change. The environment change detection unit 143 detects a change in radio quality, and determines that the radio environment has changed in a case where the radio quality has changed more than a predetermined value. In addition, a place where the radio quality greatly changes may be specified. Note that the function of the environment change detection unit 143 may be included in the data analysis unit 112 or another xApp. For example, the data analysis unit 112 may output radio analysis information including a detection result of a change in environment.

In the present example embodiment, the learning data accumulation control unit 131 selects data necessary for learning, that is, data to be accumulated, according to the change in the environment detected by the environment change detection unit 143. For example, there is a high possibility that a place where the radio quality has greatly changed is a factor that the radio environment has changed due to an arrangement change or a layout change of a shielding object and learning of the learning model has become necessary.

Therefore, the learning data is narrowed down to data of a place (area) where the radio quality greatly changes. The learning data accumulation control unit 131 narrows down the data of the specified place from the collected RAN data and accumulates the narrowed-down learning data in the learning database 132 to reduce unnecessary data.

In this manner, in a case where data is collected and accumulated by the Near-RT RIC, data to be accumulated may be selected according to a change in environment. As a result, since the learning data can be reduced, the load on the O1 interface can be further reduced.

### Fifth Example Embodiment

Next, a fifth example embodiment will be described. In the present example embodiment, an example of acquiring data from an external application server will be described. Note that the present example embodiment can be implemented in combination with any of the first to fourth example embodiments, and may be implemented by appropriately using any of the configurations of the first to fourth example embodiments.

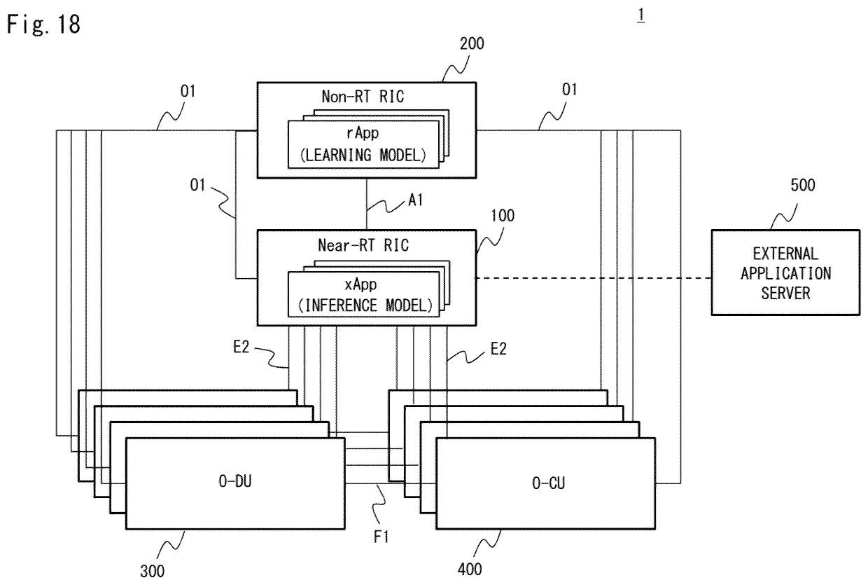

FIG. 18 illustrates a configuration example of the RAN system 1 according to the present example embodiment. As illustrated in FIG. 18, the RAN system 1 according to the present example embodiment includes an external application server 500 in addition to the configuration of the first example embodiment. Other configurations are, for example, similar to those of the first example embodiment. The Near-RT RIC 100 and the external application server 500 are communicably connected via an arbitrary interface. A general application server may be connected by an interface for providing data. Note that the Non-RT RIC 200 and the external application server 500 may be communicably connected.

The external application server 500 is a server outside the RAN including at least the O-DU 300 and the O-CU 400. It can also be said that the external application server 500 is a server outside the system including the O-DU 300, the O-CU 400, the Non-RT RIC 200, and the Near-RT RIC 100. The external application server 500 is a data providing apparatus that provides application data. For example, the external application server 500 may be a web server or a social networking service (SNS) server, may be a management server of an automated guided vehicle (AGV) system or an autonomous mobile robot (AMR) system, may be a management server of an automobile in-line travel system or an automatic driving system, may be a management server of an automatic construction system, or may be a server that executes an application that provides a predetermined service in cooperation with the RAN. The external application server 500 only needs to be able to provide application data to the Near-RT RIC 100, and may be, for example, a server on the Internet. The external application server 500 may be a physical server or a virtual server on a cloud.

The application data is data related to an application generated by the external application server 500, and is external data that cannot be collected inside the RAN. The application data may include information regarding a status of the application or information regarding a communication requirement of the application. The information regarding the status of the application is, for example, a position, a moving speed, a moving trajectory, and the like for each UE. The information regarding the communication requirement of the application is, for example, a communication quality requirement condition for each UE. The application data may also include various other data that can be used to infer the inference model of the Near-RT RIC 100. For example, weather information, traffic information, map information, and the like may be included.

In the present example embodiment, the Near-RT RIC 100 collects application data from the external application server 500 and uses the application data for inference. That is, in the Near-RT RIC 100, the inference model performs inference using the RAN data collected from either or both of the O-DU 300 and the O-CU 400 and the application data collected from the external application server 500 as inference data, and controls either or both of the O-DU 300 and the O-CU 400.

In addition, the Near-RT RIC 100 accumulates application data used for inference and transfers the application data to the Non-RT RIC 200 as learning data. That is, data selected from the RAN data and the application data as inference data and the radio analysis information and the radio control information as inference result data is accumulated in the learning database 132 as learning data, and the accumulated learning data is transferred to the Non-RT RIC 200. The Near-RT RIC 100 acquires the transferred learning data and learns the learning model by using, for example, the RAN data, the application data, the radio analysis information, and the radio control information included in the learning data.

In this way, the Near-RT RIC may obtain the application data from the external application server and use it for inference along with the RAN data from the E2 node. Accordingly, it is possible to control a radio network suitable for various situations and applications. In addition, the application data used for inference in the Near-RT RIC is transferred to the Non-RT RIC as learning data together with the RAN data and the like. As a result, the learning data in which the RAN data and the like and the application data are consistent can be created and transmitted to the Non-RT RIC 200. In addition, since it is not necessary to redundantly collect the application data as the inference data and the learning data, it is possible to reduce the communication load of the communication line between the external application server and the system including the O-DU 300, the O-CU 400, the Non-RT RIC 200, and the Near-RT RIC 100.

Note that the present disclosure is not limited to the above-described example embodiments, and can be appropriately modified without departing from the scope.

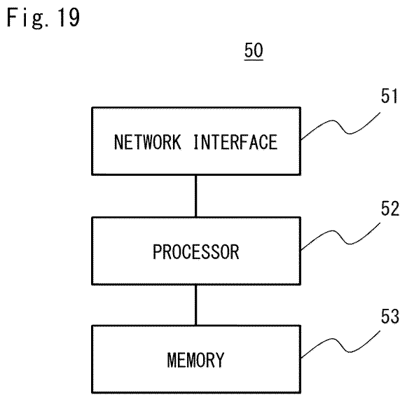

Each configuration in the above-described example embodiments may be implemented by hardware, software, or both, and may be implemented by one piece of hardware or software or by a plurality of pieces of hardware or software. Each apparatus including the Non-RT RIC and the Near-RT RIC and each function (processing) may be realized by a computer 50 including a network interface 51, a processor 52 such as a central processing unit (CPU), and a memory 53 which is a storage device as illustrated in FIG. 19. The network interface 51 may include a network interface card (NIC) for communicating with apparatuses including network nodes. For example, a program for performing the method (control method) in the example embodiment may be stored in the memory 53, and each function may be realized by executing the program stored in the memory 53 by the processor 52.

These programs include a group of commands (or software codes) causing a computer to perform one or more of the functions described in the example embodiments in a case of being read by the computer. The program may be stored in a non-transitory computer readable medium or a tangible storage medium. As an example and not by way of limitation, the computer readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer readable medium or a communication medium. By way of example, and not limitation, transitory computer-readable or communication media include electrical, optical, acoustic, or other forms of propagated signals.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as in the following Supplementary Notes, but are not limited to the following Supplementary Notes.

### Supplementary Note 1

A control system including:
a collection means for collecting specifying data to be used for specifying by a specific model configured to specify control related to a radio network; and
a transmission means for transmitting the specifying data to another control system that performs learning by a learning model as learning data to be used for the learning model configured to learn the control related to the radio network.

### Supplementary Note 2

The control system according to Supplementary Note 1, in which the specific model is constructed by the learning model that has performed the learning.

### Supplementary Note 3

The control system according to Supplementary Note 1 or 2, in which the learning data includes specified result data that is a result specified by the specific model using the specifying data.

### Supplementary Note 4

The control system according to any one of Supplementary Notes 1 to 3, further including a selection means for selecting the learning data to be used for learning by the learning model from the specifying data to be collected,
in which the transmission means transmits the selected learning data.

### Supplementary Note 5

The control system according to Supplementary Note 4, in which the selection means selects the learning data based on a position of a user terminal corresponding to the specifying data.

### Supplementary Note 6

The control system according to Supplementary Note 4 or 5, in which the selection means selects the learning data based on a change in environment corresponding to the specifying data.

### Supplementary Note 7

The control system according to any one of Supplementary Notes 1 to 6, further including an accumulation means for accumulating the learning data to be transmitted,
in which the transmission means transmits integrated data obtained by integrating the accumulated learning data.

### Supplementary Note 8

The control system according to Supplementary Note 7, in which the accumulation means accumulates learning data including specifying data collected from a plurality of nodes included in the radio network.

### Supplementary Note 9

The control system according to any one of Supplementary Notes 1 to 8, in which the transmission means transmits the learning data according to a communication status between the control system and the other control system.

### Supplementary Note 10

The control system according to any one of Supplementary Notes 1 to 9, in which the transmission means transmits the learning data according to another traffic transmitted from the control system to the other control system.

### Supplementary Note 11

The control system according to any one of Supplementary Notes 1 to 10, in which in a case where transmitting a plurality of pieces of the learning data, the transmission means transmits the learning data according to a priority of each piece of the learning data.

### (Supplementary Note 12

The control system according to any one of Supplementary Notes 1 to 11, in which the transmission means transmits compressed data obtained by dimensionally compressing the learning data.

### (Supplementary Note 13

The control system according to any one of Supplementary Notes 1 to 12, in which the collection means adjusts a frequency of collecting the specifying data according to a change in the collected specifying data.

### Supplementary Note 14

The control system according to any one of Supplementary Notes 1 to 13, in which the transmission means adjusts time granularity of the learning data to be transmitted according to the change in the collected specifying data.

### Supplementary Note 15

The control system according to any one of Supplementary Notes 1 to 14, further including a learning means for generating a learning model learned using the specifying data and updating the specific model using the generated learning model.

### Supplementary Note 16

The control system according to any one of Supplementary Notes 1 to 15, in which the control system and the other control system include a radio access network (RAN) intelligent controller (RIC) that controls a RAN.

### Supplementary Note 17

The control system according to Supplementary Note 16, in which
the control system includes a Near-RT (Real Time) RIC, and
the other control system includes a Non-RT RIC.

### Supplementary Note 18

A control system including:
a reception means for receiving, as learning data, specifying data collected by another control system to specify control related to a radio network by a specific model from the other control system; and
a learning means for learning control related to the radio network by a learning model using the learning data.

### Supplementary Note 19

The control system according to Supplementary Note 18, in which the learning means applies the learning model on which the learning has been performed to the specific model.

### Supplementary Note 20

A control device including:
a collection means for collecting specifying data to be used for specifying by a specific model configured to specify control related to a radio network; and
a transmission means for transmitting the specifying data to another control system that performs learning by a learning model as learning data to be used for the learning model configured to learn the control related to the radio network.

### Supplementary Note 21

A control device including:
a reception means for receiving, as learning data, specifying data collected by another control system to specify control related to a radio network by a specific model from the other control system; and
a learning means for learning control related to the radio network by a learning model using the learning data.

### Supplementary Note 22

A control method including:
collecting specifying data to be used for specifying by a specific model configured to specify control related to a radio network; and
transmitting the specifying data to another control system that performs learning by a learning model as learning data to be used for the learning model configured to learn the control related to the radio network.

### Supplementary Note 23

A control method including:
receiving, as learning data, specifying data collected by another control system to specify control related to a radio network by a specific model from the other control system; and
learning control related to the radio network by a learning model using the learning data.

### Supplementary Note 24

A non-transitory computer readable medium storing a control program for causing a computer to execute:
collecting specifying data to be used for specifying by a specific model configured to specify control related to a radio network; and
transmitting the specifying data to another control system that performs learning by a learning model as learning data to be used for the learning model configured to learn the control related to the radio network.

### Supplementary Note 25

A non-transitory computer readable medium storing a control program for causing a computer to execute:
receiving, as learning data, specifying data collected by another control system to specify control related to a radio network by a specific model from the other control system; and
learning control related to the radio network by a learning model using the learning data.

### Reference Signs List

1 RAN SYSTEM
10 FIRST CONTROL SYSTEM
11 COLLECTION UNIT
12 TRANSMISSION UNIT
20 SECOND CONTROL SYSTEM
21 RECEPTION UNIT
22 LEARNING UNIT
30 FIRST CONTROL DEVICE
40 SECOND CONTROL DEVICE
50 COMPUTER
51 NETWORK INTERFACE
52 PROCESSOR
53 MEMORY
100 NEAR-RT RIC
101 E2 COMMUNICATION UNIT
102 O1 COMMUNICATION UNIT
103 A1 COMMUNICATION UNIT
111 DATA COLLECTION UNIT
112 DATA ANALYSIS UNIT
113 CONTROL CONTENT SPECIFYING UNIT
120 MODEL STORAGE UNIT
121, 121a, 121b INFERENCE MODEL
131 LEARNING DATA ACCUMULATION CONTROL UNIT
132 LEARNING DATABASE
133 LEARNING DATA TRANSMISSION UNIT
141 LEARNING UNIT
142 DATA CHANGE DETECTION UNIT
143 ENVIRONMENT CHANGE DETECTION UNIT
200 NON-RT RIC
201 O1 COMMUNICATION UNIT
202 A1 COMMUNICATION UNIT
211 SYSTEM MANAGEMENT UNIT
212 LEARNING UNIT
220 MODEL STORAGE UNIT
221, 221a, 221b LEARNING MODEL
300 O-DU
400 O-CU
500 EXTERNAL APPLICATION SERVER

What is claimed is:

1. A control system comprising:
a memory configured to store instructions, and
a processor configured to execute the instructions to;
collect specifying data to be used for specifying by a specific model configured to specify control related to a radio network; and
transmit the specifying data to another control system that performs learning by a learning model as learning data to be used for the learning model configured to learn the control related to the radio network.

2. The control system according to claim 1, wherein the specific model is constructed by the learning model that has performed the learning.

3. The control system according to claim 1, wherein the learning data includes specified result data that is a result specified by the specific model using the specifying data.

4. The control system according to claim 1, wherein the processor is further configured to execute the instructions to select the learning data to be used for learning by the learning model from the specifying data to be collected, and transmit the selected learning data.

5. The control system according to claim 4, wherein the processor is further configured to execute the instructions to select the learning data based on a position of a user terminal corresponding to the specifying data.

6. The control system according to claim 4, wherein the processor is further configured to execute the instructions to select the learning data based on a change in environment corresponding to the specifying data.

7. The control system according to claim 1, any wherein the processor is further configured to execute the instructions to accumulate the learning data to be transmitted, and
transmit integrated data obtained by integrating the accumulated learning data.

8. The control system according to claim 7, wherein the processor is further configured to execute the instructions to accumulate learning data including specifying data collected from a plurality of nodes included in the radio network.

9. The control system according to claim 1, wherein the processor is further configured to execute the instructions to transmit the learning data according to a communication status between the control system and the other control system.

10. The control system according to claim 1, any wherein the processor is further configured to execute the instructions to transmit the learning data according to another traffic transmitted from the control system to the other control system.

11. The control system according to claim 1, wherein the processor is further configured to execute the instructions to, in a case where transmitting a plurality of pieces of the learning data, transmit the learning data according to a priority of each piece of the learning data.

12. The control system according to claim 1, any wherein the processor is further configured to execute the instructions to transmits-transmit compressed data obtained by dimensionally compressing the learning data.

13. The control system according to claim 1, wherein the processor is further configured to execute the instructions to adjust a frequency of collecting the specifying data according to a change in the collected specifying data.

14. The control system according to claim 1, wherein the processor is further configured to execute the instructions to adjusts-adjust time granularity of the learning data to be transmitted according to the change in the collected specifying data.

15. The control system according to claim 1, wherein the processor is further configured to execute the instructions to generate a learning model learned using the specifying data and update the specific model using the generated learning model.

16. The control system according to claim 1, wherein the control system and the other control system include a radio access network (RAN) intelligent controller (RIC) that controls a RAN.

17. The control system according to claim 16, wherein
the control system includes a Near-RT (real time) RIC, and
the other control system includes a Non-RT RIC.

18. A control system comprising:
a memory configured to store instructions, and a processor configured to execute the instructions to;
receive, as learning data, specifying data collected by another control system to specify control related to a radio network by a specific model from the other control system; and
learn control related to the radio network by a learning model using the learning data.

19. The control system according to claim 18, wherein the processor is further configured to execute the instructions to apply the learning model on which the learning has been performed to the specific model.

20.-21 (canceled)

22. A control method comprising:
collecting specifying data to be used for specifying by a specific model configured to specify control related to a radio network; and
transmitting the specifying data to another control system that performs learning by a learning model as learning data to be used for the learning model configured to learn the control related to the radio network.

23.-25. (canceled)
